(19) United States
(12) Patent Application Publication
(10) Pub. No.: US 2011/0281249 A1
(43) Pub. Date: Nov. 17, 2011

(54) Method And System For Creating Personalized Workout Programs

(76) Inventors: Nicholas Gammell, San Francisco, CA (US); Samuel Morrell, San Francisco, CA (US); Dereck Rasmussen, San Francisco, CA (US)

(21) Appl. No.: 13/108,961

(22) Filed: May 16, 2011

Related U.S. Application Data
(60) Provisional application No. 61/334,789, filed on May 14, 2010.

(51) Int. Cl. G09B 19/00

(52) U.S. Cl. 434/247

(57) ABSTRACT

A method and system for creating personalized workout programs are disclosed. According to one embodiment, a computer-implemented method comprises receiving first input data from a client device, the first input data comprising personal information, fitness goal information, and scheduling data. Based on the first input data, a recommended workout schedule and a recommended list of activity groups are generated. Second input data is received from the client device, the second input data comprising feedback related to the recommended list of activity groups. Based on the first input data and second input data, a personalized workout plan is generated. The personalized workout plan is transmitted and displayable on the client device.

The present application claims the benefit of and priority to U.S. Provisional Patent Application No. 61/334,789 entitled “A METHOD AND SYSTEM FOR CREATING PERSONALIZED WORKOUT PROGRAMS” filed on May 14, 2010, and is hereby incorporated by reference.

### FIELD

The field of the invention relates generally to computer systems. In particular, the present invention is directed to a method and system for creating personalized workout programs.

### BACKGROUND

Physical exercise, or a workout program, includes any bodily activity that enhances or maintains physical fitness and overall health and wellness. It is performed for various reasons including strengthening muscles and the cardiovascular system, honing athletic skills, weight loss or maintenance, as well as for the purpose of enjoyment. Workout programs can be centered around restructuring lifestyle while helping to provide the necessary motivation for its success.

### SUMMARY

A method and system for creating personalized workout programs are disclosed. According to one embodiment, a computer-implemented method comprises receiving first input data from a client device, the first input data comprising personal information, fitness goal information, and scheduling data. Based on the first input data, a recommended workout schedule and a recommended list of activity groups are generated. Second input data is received from the client device, the second input data comprising feedback related to the recommended list of activity groups. Based on the first input data and second input data, a personalized workout plan is generated. The personalized workout plan is transmitted and displayable on the client device.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

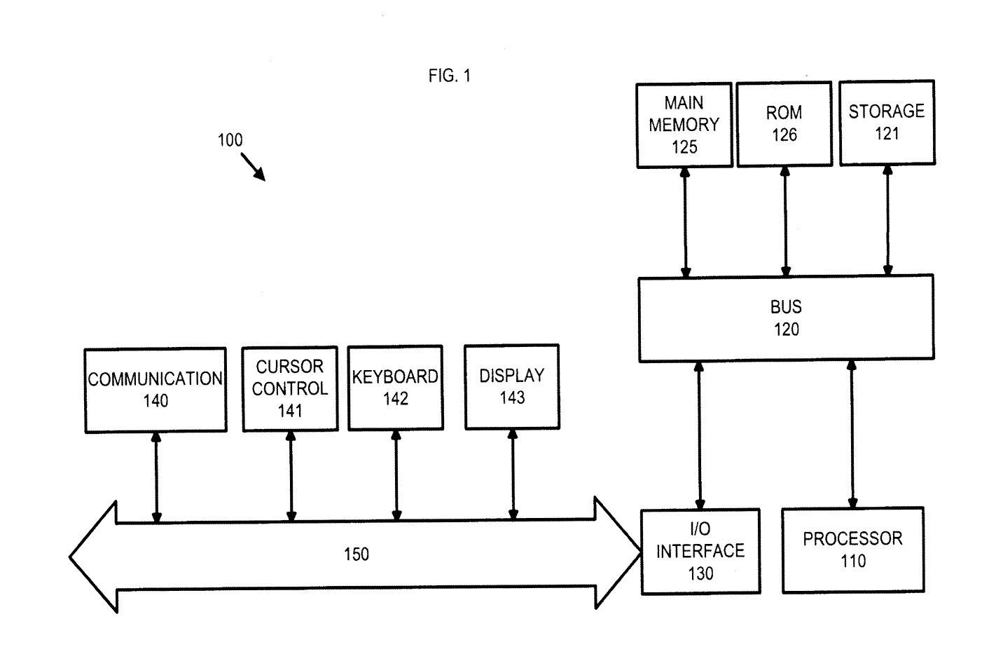

FIG. 1 illustrates an exemplary computer architecture for use with the present system, according to one embodiment.

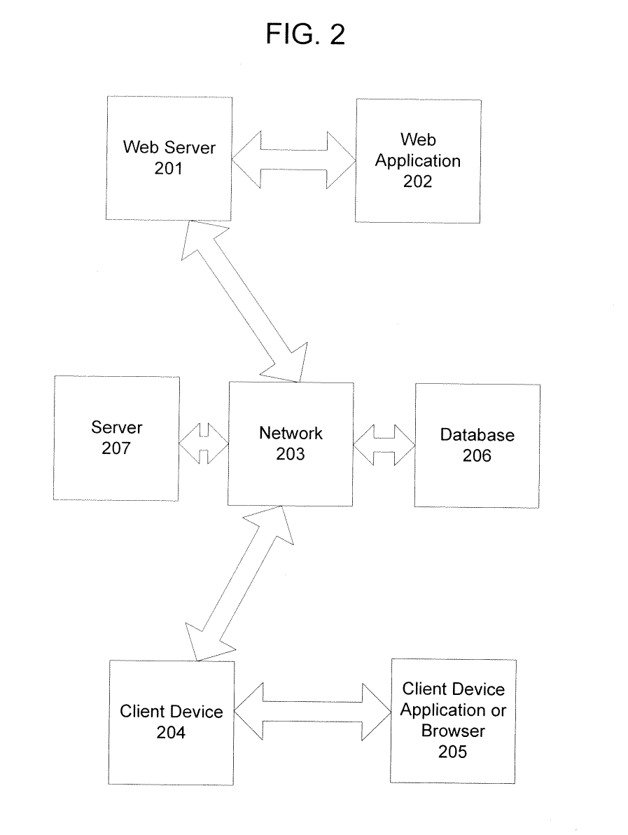

FIG. 2 illustrates an exemplary system layout for use with the present system, according to one embodiment.

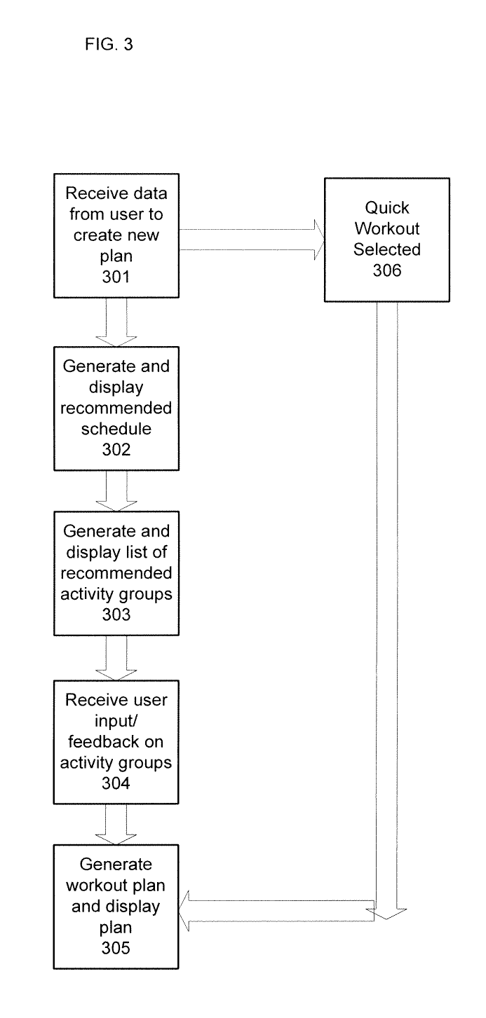

FIG. 3 illustrates an exemplary personalized workout creation process for use with the present system, according to one embodiment.

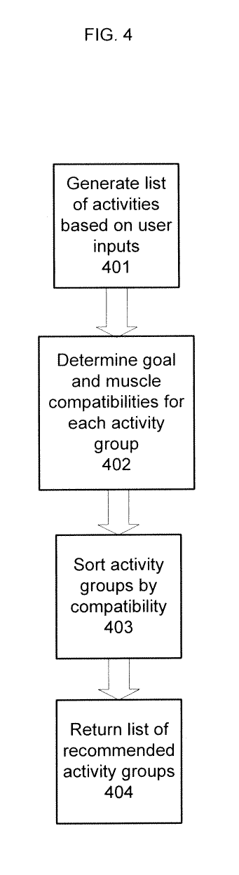

FIG. 4 illustrates an exemplary process for generating a list of activity groups for use with the present system, according to one embodiment.

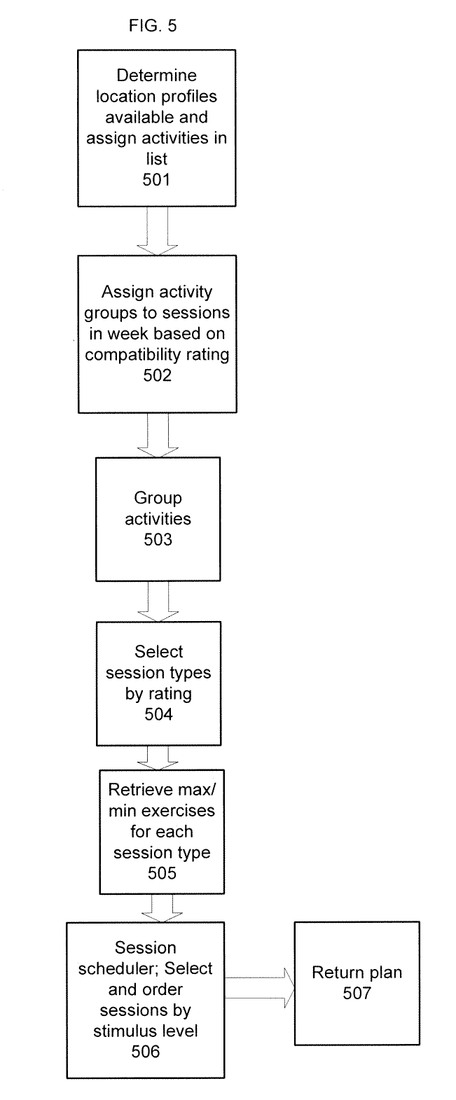

FIG. 5 illustrates an exemplary weekly scheduling process for use with the present system, according to one embodiment.

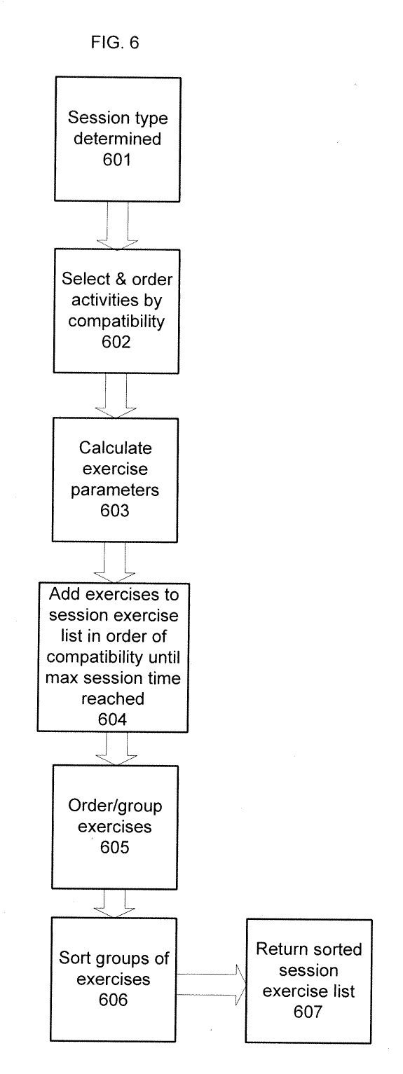

FIG. 6 illustrates an exemplary session scheduling process for use with the present system, according to one embodiment.

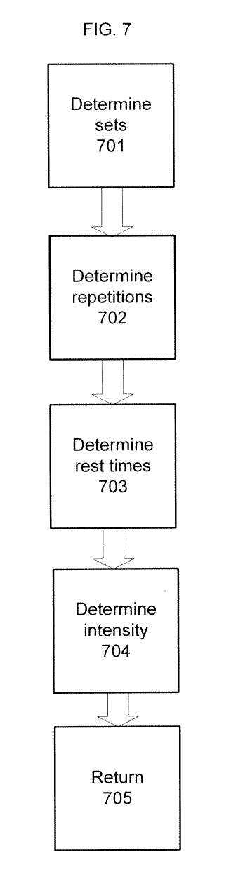

FIG. 7 illustrates an exemplary process for determining exercise sets, repetitions, and rest for use with the present system, according to one embodiment.

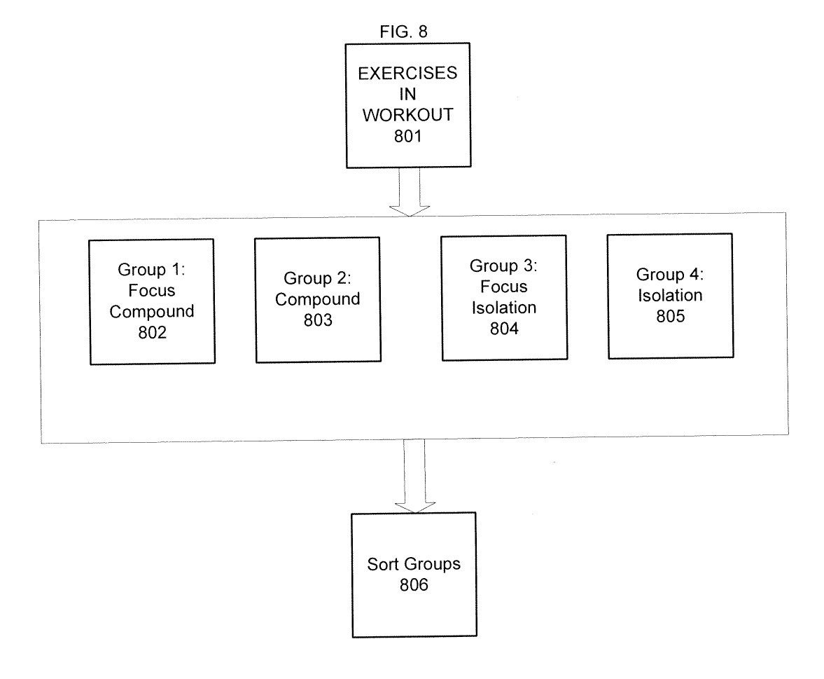

FIG. 8 illustrates an exemplary workout plan for use with the present system, according to one embodiment.

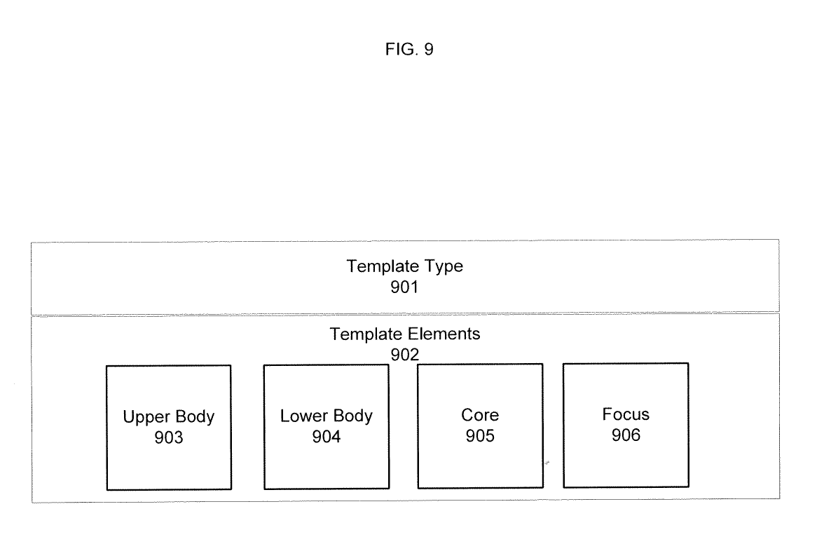

FIG. 9 illustrates an exemplary session template for use with the present system, according to one embodiment.

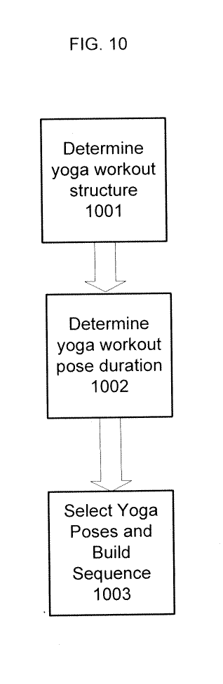

FIG. 10 illustrates an exemplary yoga workout generation process for use with the present system, according to one embodiment.

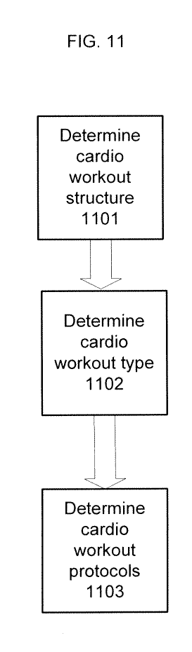

FIG. 11 illustrates an exemplary cardio workout generation process for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for creating personalized workout programs are disclosed. According to one embodiment, a computer-implemented method comprises receiving first input data from a client device, the first input data comprising personal information, fitness goal information, and scheduling data. Based on the first input data, a recommended workout schedule and a recommended list of activity groups are generated. Second input data is received from the client device, the second input data comprising feedback related to the recommended list of activity groups. Based on the first input data and second input data, a personalized workout plan is generated. The personalized workout plan is transmitted and displayable on the client device.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present method and system creates personalized workout programs based on information submitted by users. The present method and system evaluate data about an individual's body, fitness goals, resources, schedule, and activity preferences to recommend specific exercise protocols to improve their physical fitness. The process incorporates practical standards and proven training methodologies from the fields of physiology and exercise science to tailor workout recommendations to individuals' specific training goals. Along with information submitted by users, exercises from multiple types of physical activity—including resistance exercises, cardio, sports, mind-body disciplines, flexibility, and everyday activities, such as walking the dog, climbing stairs, or doing yard work—are mapped to a diversity of variables affecting exercise prescription. Each of the different activity types and exercises are scored and prioritized to recommend those most appropriate to each individual.

It is noted that throughout the description provided herein, references to resistance training, resistance, and strength training are used interchangeably.

According to one embodiment, a set of questions are provided through a user interface to collect data from individuals.

According to one embodiment, the present system is integrated with an email system, digital calendaring system, mobile phone applications, social networks, a fitness monitoring dashboard, and a customized workout video system. The present system collects user feedback on workouts and overall progress, and adapts workout recommendations based on that feedback.

According to one embodiment, data collected from users allows refinement of the process using machine learning and analysis of their reported results.

According to one embodiment, a movement pattern is defined as a movement of an articulation or set of articulations of the human body. An example of a movement pattern is an upper body push.

According to one embodiment, a base exercise is defined as a non specific exercise movement. An example of a base exercise is a flat press.

According to one embodiment, an exercise is defined as a specific exercise defined by equipment, level, difficulty, and engaged muscles. An example of an exercise is barbell bench press.

Exemplary input variables, middle layer variables, and output variables that are included in workout plan recommendations include body inputs, fitness goals inputs, resources available to the individual, and schedule inputs, according to one embodiment. Detailed descriptions of exemplary variables are as follows.

According to one embodiment, inputs for body include age, sex, height, weight, and fitness level. The present system provides a set of groupings for different body shapes that includes at least 25 different body shapes for men and at least 20 different body shapes for women. The present system includes body inputs such as waist, thigh, chest, and shoulder girth, as well as other anthropometrics like body fat percentage and resting heart rate.

According to one embodiment, the present system asks users to select a primary fitness goal, examples include muscle, fat loss, health and longevity, strength, endurance, speed/power, flexibility, and tone. Users can also select a body part focus (or foci), as well as the intensity level they desire for their workouts. The present system includes digital drawings of bodies to customize how users select body parts and muscle foci. Based on a calculation involving the user's height, weight and sex, the present system generates a specific body image or set of images, with which the user can interact.

The present system allows the selection of different goals for different body parts, allows for the granular selection of specific muscle foci, and increases the number of workout intensity options.

According to one embodiment, inputs for resources include responses to a series of questions about what general resources users have access to at different potential workout locations. Questions are based on general types of equipment common to specific locations, examples include at least the following:
Gym: resistance equipment, cardio equipment, group exercise classes.
Home: resistance equipment, cardio equipment, other.
Outdoors: bicycle, running shoes, swimming pool, other.
Group exercise: aerobics class, yoga or pilates class, other.
Sports: football, volleyball, basketball, tennis, baseball, boxing, soccer, bowling, golf, hockey, other.

According to one embodiment, location profiles allow users to select specific pieces of equipment and resources used for fitness activity in different buckets corresponding to above mentioned locations where they have access.

According to one embodiment, inputs for the scheduling of workouts include a weekly schedule where users enter how many minutes they can exercise each day in a typical week.

The present system tracks what times of day users can exercise for a given time period, and integrates the scheduling with the resources inputs so that users can indicate what days and times they have access to which specific resources.

According to one embodiment, the present system uses the user's inputs to score different activities and specific exercises based on level and intensity compatibility, fitness goal, muscle focus, available resources, and schedule. Sex, age, and body shape are incorporated into scoring equations, as are feedback input by the specific user and from other users.

The present system presents users with a prioritized list of exercises and activities, with each exercise or activity highlighted in green, yellow, or red to indicate its relative compatibility based on the users' inputs. Users are able to accept the recommended fitness activities and exercises and build their workout program. Users may also override the system's recommendations by deleting activities and exercises, or selecting different ones based on their personal preferences.

Users view additional content that explains why specific exercises or activities were recommended, what the specific benefits are, and other content which may help them decide what activities and exercises to include in their workout plans.

According to one embodiment, the present system includes a database of physical activities and exercises that includes resistance exercises, cardio exercises, sports, mind-body disciplines, everyday activities, and flexibility exercises. The database maps each individual exercise or activity to a large set of related data, including various exercise classifications, required facilities, primary and secondary muscle groups, primary and secondary muscle foci, fitness level, goal compatibility, difficulty, and predominant energy systems. Resistance exercises, for example, map to additional related data including lift type, movement pattern, and lifting group. Sports, cardio, and everyday activity exercises, for example, map to additional related data called metabolic equivalents.

According to one embodiment, the present system recommends detailed workout plans based on several variables input by each individual user accessing the system. The exercises and activities in the exercise database are filtered, scored, and then presented to users for feedback. Using the feedback, exercises are allocated to a schedule and paired with appropriate exercise protocols, such as sets, reps, rest, weight amount, workout time, and intensity level. Each of these steps takes into account relevant variables input by users and principles of exercise science.

According to one embodiment, the present system includes:
Calendar API integrations (to sync user's schedule/calendar with Outlook, Google Calendar, Apple iCal, Entourage for Mac and Lotus Notes
Mobile phone/device applications
Virtual trial of potential exercise equipment—create sample workouts that incorporate a piece of exercise equipment users may want to purchase
Exercise videos compiled by recombining and splicing video content to match the results of our personalized workout programs
Audio instructions and motivational content created to match the results of the algorithm
Simplified tracking systems that use voice or picture reporting—picture of a loaded barbell to calculate weight, recording of someone saying, “Deadlift, 315 pounds, two sets of six repetitions.”
3D avatars of users created from 2D images to track progress and facilitate goal setting—would allow the user to manipulate his avatar to envision the results of a period of exercise toward a goal or goals.

According to one embodiment, a microcycle schedule is the distribution of activities and exercises throughout the week. An example includes resistance training on Monday, Wednesday and Friday, with yoga on Tuesday and Thursday.

Inputs: Schedule (# Days per week), Muscle Focus

### Outputs: Session Type by Day for Microcycle

Recommended number of lifting days:
# of Lifting Days per week by Goal

Muscle 2-5

Fat Loss 1-4

H&L 1-3

Strength 2-5

Endurance 1-4

# of Lifting Days per week by Level

Beginner 1-3

Intermediate 1-4

Advanced 2-5

Expert 3-5

# of Lifting Days per week by Intensity

Low 1-2

Moderate 2-4

High 3-5

### Exemplary Rules:

No more than 4 high-stimulus days/week

No more than 2 high-stimulus days back to back

Hit each muscle group no more than 3/week with high-stimulus

According to one embodiment, a session schedule is the distribution of exercises and activities within a single dedicated period of training, usually lasting 15-90 minutes from start to finish.

### Inputs: Session Type, Fitness Goal, Muscle Focus, Lift Category, Time Available

### Outputs: Movement Pattern List Schedule by Session

### Exemplary Rules:

Compound exercises before Isolation exercises

Large muscle groups before small muscle groups

Higher intensity exercises before lower intensity exercises

Hit muscle focus early in workout

Use non-competing pairs

Use pairs/circuits with similar weight

Use pairs/circuits with similar equipment

According to one embodiment, non-resistance exercise scoring determines the appropriateness of non-resistance activities and exercises by evaluating their compatibility with user inputs.

### Inputs: Muscle Focus, Fitness Goal, Fitness Level, Desired Intensity

### Outputs: Exercise Score and Color Coding

### Exemplary Rules:

Goal, level and intensity compatibility constrain the field of recommended non-resistance exercises.

Muscle Focus is very important if resistance isn't part of the overall program, but the user nonetheless has a muscular focus.

If resistance training is part of the overall program, then muscle focus (for non-resistance exercises) is less important.

If the non-resistance exercise is anaerobically demanding, it counts as a high-stimulus workout for the muscles involved.

According to one embodiment, resistance exercise scoring determines the appropriateness of resistance exercises by evaluating their compatibility with user inputs.

### Inputs: Movement Pattern, Lifting Group, Muscle Focus, Equipment/Facilities

### Outputs: Exercises

Exemplary Rules:

Remove exercises with equipment or difficulty constraints

equipment

difficulty

Determine appropriateness

emphasize muscle focus

include variety of movement patterns or lifting groups within session

Prioritize compound exercises.

According to one embodiment, repetition schemes determine how many repetitions constitute one set and how many sets the user should perform.

Inputs: Goal, Fitness Level, Desired Intensity, Lift Type (compound or isolation)

### Outputs: Potential Rep Schemes

### Set and Rep Ranges by Goal:

Rep Ranges: Muscle 5-12, Fat Loss 8-15, Health & Longevity 8-15, Strength 1-8, Endurance 12-100

Set Ranges: Muscle 2-6, Fat Loss 2-4, Health & Longevity 1-3, Strength 2-6, Endurance 2-3

### Set and Rep Ranges by Level:

Rep Ranges Beginner 8-100, Intermediate: 5-100, Advanced 1-100, Expert 1-100

Set Ranges: Beginner 1-3, Intermediate 2-5, Advanced 2-8, Expert 2-10

### Set and Rep Ranges by Lift Type

Rep Ranges: Compound 1-100, Isolation 6-100, Combo 6-100

Set Ranges: Compound 1-10, Isolation 1-4, Combo 1-10

### Exemplary Rules:

Lower reps early, higher reps late

More sets on focus muscles

More sets on compound exercises

When training with 10 or fewer reps, higher intensity means lower reps and more weight.

### Exemplary Exceptions:

Exercises with less time under tension per rep (e.g. calf Raises, crunches) need higher rep schemes

Fixed resistance exercises (e.g. bodyweight squats, pushups) need higher rep schemes as well, and sometimes they need indefinite rep schemes, like as many as possible (AMAP) or close to failure (CTF).

According to one embodiment, a rest time process determines the length of rest periods between sets of resistance exercises. Rest periods can occur within a pair or circuit or between single exercises, pairs or circuits.

### Inputs: Goal, Fitness Level, Desired Intensity, Rep Scheme, Lift Type

Outputs: Rest between Circuit Exercises, Rest between Single Exercises, Rest between Circuits

### Rest Period Ranges:

Between Circuit Exercises: Muscle 30-90 s, Fat Loss 0-60 s, Health & Longevity (H&L) 15-60 s, Strength 120-180 s, Endurance 0-30 s

Between Single Exercises: Muscle 45-90 s, Fat Loss 15-60 s, H&L 30-60 s, Strength 120-130 s, Endurance 30-45 s

Between Circuits: Muscle 90-120 s, Fat Loss 45-90 s, H&L 60-120 s, Strength 120-300 s, Endurance 30-120 s

### Exemplary Rules:

The heavier the weight, as a percentage of 1RM, the more rest necessary

Similarly, the lower the reps, the more rest necessary

When training with more than 10 reps, higher intensity means less rest.

According to one embodiment, a weight prescriptions process recommends particular weights or weight ranges for resistance exercises.

### Inputs: Goal, Fitness Level, Movement Pattern, Lifting Group, 1RM (Single Repetition Maximum Weight)

### Outputs: Weights

### Weight Range by Goal:

Muscle: 6-12 repetitions at 67-85% of 1RM (Single Repetition Maximum)

Fat Loss: 8-15 repetitions at 65-80% 1RM

H&L: 8-20 repetitions at 60-80% 1RM

Strength: 1-8 repetitions at 80-100% 1RM

Endurance: 12-100 repetitions at 67% or less.

### Weight Range by Level:

Beginner: 8-20 repetitions, 60-80% 1RM

Intermediate: 3-20 repetitions, 60-93% 1RM

Advanced: 1-20 repetitions, 60-100% 1RM

Expert: 1-20 repetitions, 60-100% 1RM

### Weight Range by Intensity:

Low: 8-20 repetitions

Moderate: 6-20 repetitions

High: 1-20 repetitions

### Weight Range by Lift Type:

Compound: 1-20 repetitions

Isolation: 6-20 repetitions

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates an exemplary system layout for use with the present system, according to one embodiment. A web server 201 is in communication with a network 203 and a web application 202. The web server 201 provides access to a website running the web application 202. A database 206 for storing user inputs and system data is in communication with the network 203. A server 207 is in communication with the network 203. A client device 204 running a client device application or browser 205 is also in communication with the network 203. The client device application or browser 205 provides access to a personalized workout creation system according to one embodiment. Examples of a client device include yet are not limited to smart phones, mobile internet devices, laptop computers, desktop computers, tablet PCs, and any system providing similar capabilities as enabled by an architecture described in FIG. 1. According to one embodiment, the server, web server, database, and client device include architectures as depicted in FIG. 1.

FIG. 3 illustrates an exemplary personalized workout creation process for use with the present system, according to one embodiment. According to one embodiment, a user enters data for creating a new workout plan 301. Exemplary data to be received from a user includes the user's birth date for age calculation, height, weight, goals, level, muscle focus, activities, and scheduling data. Exemplary scheduling data includes the minutes per day, days per week, and number of weeks the user is interested in including in the workout plan. A recommended schedule is generated and displayed to the user 302, and the recommended schedule includes suggested days of the week marked for workouts. A list of recommended activity groups is generated and displayed to the user 303. The list of recommended activity groups is generated based on user goals, level, muscle focus, and available facilities. The user provides feedback by indicating preferred (or not preferred) activity groups 304 and a workout plan is generated and displayed to the user 305. According to one embodiment, the workout plan is generated using a process similar to those depicted in the figures and corresponding description that follows. According to one embodiment, a user may select a quick workout process 306 and generate a single day workout.

FIG. 4 illustrates an exemplary process for generating a list of activity groups for use with the present system, according to one embodiment. A list of activities is generated based on inputs received from the user 401. The list of activities includes all activities where the activity goal matches the user goal, the activity level does not exceed the desired level indicated by the user, and the facilities available to the user include facilities required by the activity. Goal and muscle compatibilities are then computed for each activity group 402. Goal compatibilities per activity include a count of how many goals of an activity have goals that match the user's goal. Muscle compatibilities per activity include a count of how many muscles targeted by an activity target a muscle group that matches the user's muscle group focus. A maximum goal compatibility designation is assigned to the activity having the highest in goal compatibilities. A maximum muscle compatibility designation is assigned to the activity having the highest in muscle compatibilities. For each activity group, a goal compatibility is calculated using the activity goal compatibility (divided by the maximum goal compatibility. For each activity group, a muscle compatibility is calculated using the activity muscle compatibility (divided by the maximum muscle compatibility). The total compatibility for the activity group is calculated (a calculation of (group goal compatibility+the group muscle compatibility)/2).

Once the total compatibility for each activity group is calculated, the activity group list is sorted by compatibility 403 and the list of recommended activity groups is returned 404.

FIG. 5 illustrates an exemplary weekly scheduling process for use with the present system, according to one embodiment. Available location profiles are determined and activities are assigned 501. Exemplary facility groups include home, gym, outside. Activity groups are assigned to sessions in the week based on compatibility rating 502, and are grouped according to facilities and compatible body parts 503. Session types are selected by rating 504 based on muscle focuses and goal. Maximum and minimum exercises for each session type are retrieved 505 and then a session scheduler is run for each session 506 (sessions are selected and ordered by stimulus level as well). After repeating running the session scheduler appropriately for each session, cycling through intensities, number of weeks, the plan is returned 507.

FIG. 6 illustrates an exemplary session scheduling process for use with the present system, according to one embodiment. According to one embodiment, once a session type is determined 601, a session warm up and cool down buffer is added based on the maximum session time. Activities are then selected and ordered based on compatibilities 602. All activities of the current activity type included in the user's refined activity group list are retrieved, ordered by compatibility (using muscle focus and goal) 602. Exercise parameters including sets, repetitions, and rest time for all activities are calculated 603. Exercise parameters can be calculated using an exemplary process depicted in FIG. 7 and the corresponding description, according to one embodiment. Exercises are then added to the session exercise list in order of compatibility 604 until the maximum session time is reached. According to one embodiment, compound exercises are added first and then the system alternates. If circuit workouts are enabled, activities are selected into circuits from different muscle groups and body parts.

According to one embodiment, the maximum session time overrides any minimum number of exercises, and any time remaining in the session is filled with warm up and cool down exercises. The exercises are then ordered and grouped 605 according to muscle focus and sorted according to number of repetitions 606. The sorted session exercise list is then returned 607. According to one embodiment, the exercises in a session are ordered according to muscle focus. An exemplary grouping is as follows:
Group 1: Less than or exactly 2 muscle focus exercises;
Group 2: Compound exercises;
Group 3: Isolation exercises;
Group 4: More than 2 muscle focus exercises.

According to one embodiment, scheduling performed for each workout plan includes recovery days, and appropriate stimulus scheduling in the optimal order. Stimulus scheduling includes intensity according to low, moderate, and high stimulus days.

FIG. 7 illustrates an exemplary process for determining exercise sets, repetitions, and rest for use with the present system, according to one embodiment. Sets are calculated 701, repetitions are calculated 702, rest times are calculated 703, intensity is calculated 704, and parameters are returned 705. To calculate the sets, set ranges are retrieved from the input received from the user including goal, level, and lift type. A refined range is generated, and sets are selected from within the range using lift type and muscle focus. To calculate repetitions, repetition ranges are retrieved from the input received from the user including goal, level, and lift type. A refined range is generated, and using the set table a number is selected. The number is adjusted until it is within the refined range of repetitions. Rest times are calculated based on the repetitions (for example, higher number of repetitions translates to less rest time; compound has more rest time than isolation).

According to one embodiment, medium intensity is used as a baseline, and intensity for future exercise sessions is adjusted based on goals, repetitions completed, weight, as well as perceived exertion (RPE) and a user self-report. The user RPE and self report are used to adjust intensity of subsequent exercise sessions based on the following progression rules:

A. RPE Rules
IF the user completes the workout, and IF user RPE exceeds the intended range, THEN reduce the intensity in the subsequent workout
IF the user completes the workout, and IF user RPE falls below the intended range, THEN increase the intensity in the subsequent workout
IF the user does not complete the workout, and IF user RPE exceeds the intended range, THEN reduce the intensity in the subsequent workout
IF the user does not complete the workout, and IF user RPE falls below the intended range, THEN maintain the planned intensity
IF the user completes the workout, and IF user RPE meets the intended range, THEN maintain the planned intensity in the next workout.
IF the user completes >80%, and IF the RPE meets the intended range, THEN maintain the planned intensity.
IF the user completes <80%, and IF the RPE meets the intended range, THEN reduce the intensity in the next workout.

B. Self-Report Rules
Find the sweet spot! What RPE makes this user feel good? For strength? For Cardio?
Use the user's individual RPE/Wellbeing correlation to design the next mesocycle.

FIG. 8 illustrates an exemplary ordering process for use with the present system, according to one embodiment. Exercises selected from movement pattern templates are ordered according to this. An exemplary ordering process takes exercises in a workout as input 801 and orders them according to focus compound 802, compound 803, focus isolation 804, and isolation 805. The groups are ordered such that the first exercise in a workout begins with focus compound 802, and the last exercise in the workout is isolation 805. The groups are each sorted 806 by similar equipment, non-competing and competing muscle groups.

FIG. 9 illustrates an exemplary session template for use with the present system, according to one embodiment. An exemplary session template includes a template type 801. An example of a template type 801 includes elements for full body, health, and longevity, according to one embodiment. A template element 802 is defined as a set of exercises determined by movement patterns. Examples of template elements include upper body 903 (all exercises for the template type with an upper body movement pattern), lower body 904, core 905, focus 906.

FIG. 10 illustrates an exemplary yoga workout generation process for use with the present system, according to one embodiment. A yoga workout structure is determined 1001, yoga workout pose durations are calculated 1002, and yoga poses are selected for building a sequence 1003. Examples of yoga pose types include arm balances, backbends forward, bend hips down, inversions kneeling, lunges restorative, seated and twist, staggering standing, and combinations, according to one embodiment. Examples of base yoga poses include all fours, plank, standing, seated, and supine, according to one embodiment. Mapping of yoga poses includes, according to one embodiment, pose type, single sided, transition type, base pose, transition pose, restorative, exercise level, difficulty, joints worked, tendons worked, strengthen muscles, lengthen muscles, pose variations.

According to one embodiment, a yoga workout structure includes four phases (warm up, work session 1, work session 2, and cooldown/restorative). Session time is assigned according to desired percentages assigned to each phase. Pose difficulty is assigned to each pose based on the user level (input by user). Examples of pose difficulty include beginner, novice, intermediate, advanced, and expert.

According to one embodiment, pose selection includes rules regarding transition type, duplication, and variety.

FIG. 11 illustrates an exemplary cardio workout generation process for use with the present system, according to one embodiment. A cardio workout structure is determined 1101, the cardio workout type is determined 1102, and the cardio workout protocols are determined 1103. A cardio workout structure includes three phases, according to one embodiment (warm-up, work session, cool down). Exemplary phase rules include designating 20% of the workout time to warm up, 10% of the workout time to cool down, and the remaining time assigned to the work session. Exemplary cardio workout types include a regular run, a tempo run, intervals, and sprints, according to one embodiment. Cardio workout types are scored based on user inputs including fitness goal, intensity, and level. The cardio workout type receiving a highest score related to compatibility is recommended to the user. Cardio workout protocols are determined by using a table that assigns a value within protocol ranges based on the user's intensity and level inputs. Exemplary protocol ranges include the following:
Regular Run Protocol Ranges:
*RPE: 4-6
**% HRR: 65-75%
Speed: 3-7.5 MPH
Tempo Run Protocol Ranges:
   *RPE: 6-8
   **% HRR: 75-85%
   Speed: 4-9.5 MPH
Intervals Protocol Ranges:
   *RPE: 7-9
   **% HRR: 85-90%
   Speed: 4-10.5 MPH
Sprints Protocol Ranges:
   *RPE: 9-10
   **% HRR: 90-98%
   Speed: 7-12 MPH

Where RPE is defined as rate of perceived exertion (a user judgement) and % HRR is defined as percentage of heart rate reserve (a calculation based on user's maximum heart rate and resting heart rate).

According to one embodiment, a metric is employed to summarize workout stats and also to select and order exercises, and to calculate an individual's progression from week-to-week. The metric is referred to herein as total work.

Total work is calculated based on measurements of “distance under tension” (DUT) that an exerciser lifts the weight through the entire range of motion for an exercise.

DUT*[(% Bodyweight Supported*Exerciser's Bodyweight)+(% Weight Supported*Lift Weight)]=Total Work for each repetition of exercise

The DUT is calculated based on applying the linear least-squares method of statistical regression analysis to a sample set of human measurements for each Base Exercise, where the y-value (independent variable) is the height of each exerciser. The DUT value for each Base Exercise is applied to all exercises in that Base Exercise group, and the values for % Bodyweight Supported and % Weight Supported are adjusted for each individual exercise.

According to one embodiment, scores of 0-5 are assigned to various fitness qualities based on the content of a workout or workouts.

Examples of fitness qualities include:
Strength
   Maximal Strength
   Functional Strength
Endurance
   Aerobic Endurance
   Anaerobic Endurance
Flexibility
   Dynamic Flexibility
   Static Flexibility
Mobility/Movement
   Balance & Coordination
   Agility
   Speed
   Power.

According to one embodiment, an infographic is created based on the scoring methodology, assigning points to each fitness quality. The points are assigned based on time and activities.

According to one embodiment, a user's weight load recommendation is increased from week to week within a range of %'s based on the user's level and the body zone of each exercise.

According to one embodiment, a knowledge base is employed to generate exercise plans based on a number of user preferences, including time available, location, accessible equipment, current fitness level, prior training data, and user goals around body strength and wellness.

According to one embodiment, exercise activities are characterized in a knowledge base. They are grouped according to the following exemplary factors:

Exercise Activity Type. This is the basic classification of the exercise in terms of its intended purpose. Activities types include:
Cardio fitness,
Sports,
Strength training,
Mind-body activities (like yoga),
Flexibility promoting activities
Warm Up activities before rigorous training,
Cool Down activities post training

Activity. This describes the “real world” activity that the exercise is associated with. Activities include:
Bodyweight Strength Training
Free Weight Strength Training
Machine Strength Training
Band Strength Training
Aerobics
Machine Cardio
Trampoline
Treadmill Cardio
Machine Stair Climbing
Machine Ladder Climbing
Bootcamp
Step Aerobics
Spinning
Jogging
Stair Climbing
Jumping Rope
Hand Bicycling
Recumbent Bicycling
Stationary Bicycling
Machine Rowing
Elliptical Cardio
Machine Cross-country Skiing
Fartlek Running
Cardio Kickboxing
Walking
Power Walking

% Body Weight: The percentage body weight moved by the exercise. For example, a gait movement would move 100% of body weight.

% Lifted Weight. When an external weight is associated with an activity, the percentage of external weight moved by the exercise. For example, users performing a squat with external weights will move 100% of lifted weights.

Isolation or Compound Exercise Mechanics: Compound Exercises focus on functional fitness to simulate real-life activities and use a variety of body movements and a wide range of motion. Isolation exercise target a muscle or muscle group and only one joint at a time.

Level: Assessment of the degree of fitness required of the participant to successfully engage with the exercise. According to one embodiment, five level ranges are supported: Beginner, Novice, Intermediate, Advance, and Expert. Exercises are associated with a range of levels. Exemplary properties are associated with levels, including minimum and maximum reps and sets.

Facility: Equipment required by the exercise (e.g. exercise ball).

Muscle Activations: Target, Synergistic, and Stabilizing muscles associated with the exercise. For example, a simple Crunch exercise includes the following muscle activations:
Target: Upper Rectus Abdominis, Lower Rectus Abdominis
Synergists: External Obliques, Internal Obliques
Stabilizers: Iliopsoas, Tensor Fasciae Latae, Rectus Femoris, Sartorius

Durative: Indicating the exercise is one of continuous motion.

Tutorials: Tutorials in the form of videos, photo shots and coaching messages guide the user on correct posture and control through the exercise.

According to one embodiment, exercises are classified in a hierarchy of movement categories. Exercises are grouped into base exercises, which are further grouped into movement patterns. Each exercise inherits the properties of the base exercise and movement patterns that it is associated with unless these properties are explicitly defined for the exercise.

According to one embodiment, movement patterns are movements of an articulation or set of articulations of the human body. Properties that are associated with movement patterns include: the associated body zone (Upper, Core, Lower), the type of force (push or pull), mechanics (isolation or compound), the movement pattern associated with opposite movement (e.g. Abdominal Extension vs. Abdominal Flexion), associated muscle groups, and the competing movement patterns using similar muscle groups. Examples of movement patterns include:
Abdominal Extension
Abdominal Flexion
Abdominal Rotation
Abdominal Stabilization
Anterior Chain
Ankle Extension
Ankle Flexion
Elbow Extension
Elbow Flexion
Gait
Hip Abduction
Hip Adduction
Hip Extension
Hip Flexion
Upper Body Horizontal Pull
Hip Lateral rotation
Hip Medial rotation
Upper Body Horizontal Push
Hip Transverse Abduction
Hip Transverse Adduction
Knee Extension
Knee Flexion
Lower Body Hip Dominant
Lower Body Hip Dominant Unilateral
Lower Body Knee Dominant
Lower Body Knee Dominant Unilateral
Shoulder Arm Adduction
Shoulder Arm Abduction
Shoulder Arm Extension
Shoulder Arm Flexion
Shoulder Lateral Rotation
Shoulder Medial Rotation
Shoulder Scapular Depression
Shoulder Scapular Elevation
Shoulder Scapular Protraction
Shoulder Scapular Retraction
Shoulder Transverse Abduction
Shoulder Transverse Adduction
Upper Body Vertical Pull
Upper Body Vertical Push
Wrist Extension
Wrist Flexion

According to one embodiment, a workout template is an ordered set of template elements. Each template is associated with a goal and workout type. Template elements represent a set of available and movement patterns based off of the workout type and what movement patterns or exercises have already been used. Template elements can also be specific movement patterns instead of sets of movement patterns. Once a specific movement pattern has been selected from the set, an exercise within that movement pattern group is selected after unavailable exercises have been filtered out. Templates are filled until the max duration has been reached. These templates are designed by fitness experts to ensure the workouts include the essential movements based off their goal and the workout type. Multiple templates can exist for a goal and workout type if fitness experts prefer different workout styles.

An example of an Full Body, Health & Longevity workout template includes the following, according to one embodiment:
A—Any Upper Body movement pattern
B—Any Lower Body movement pattern
C—Any Core Body movement pattern
w—A focus isolation movement pattern if a user focus exist
A2—Opposite Upper Body movement pattern from the previous upper body movement pattern.
B2—Opposite Lower Body movement pattern from the previous lower body movement pattern.
C4—Any different core body movement pattern.
q—A different focus isolation movement pattern if multiple user foci exist
A4—Any Upper Body movement pattern that is different from the previous upper body movement pattern.
B4—Any Lower Body movement pattern that is different from the previous lower body movement pattern
w—(same as above)
A—(same as above)
C4—(same as above)
B4—(same as above)
q—(same as above).

According to one embodiment, base exercises are non specific exercise movements. Properties associated with base exercises include an associated movement pattern, and body and lifted weight percentages. Examples of base exercises include:
Sit-up
Crunch
Reverse Crunch
Ab Twist
Ab Plank
Ab Rollout
Compound Crunch
Leg Raise
Seated Calf Raise
Calf Raise
Toe Raise
Overhead Triceps Extension
Pushdown
Side Leg Raise
Lying Triceps Extension
Kickback
Curl
Hammer Curl
Reverse Curl
Gait
Inner Thigh
Hip Extension
High Row
Row
Flat Press
Incline Press
Decline Press
Knee Extension
Hamstring Curl
Deadlift
Single-leg Deadlift
Lunge
Step Up
Squat
Single-leg Squat
Lateral Raise
Reverse Raise
Front Raise
External Rotation
Internal Rotation
Pulldown
Scapular Depression
Shrug
Chest Fly
Scarecrow
Scapular Shrug
Vertical Pull
Shoulder Press
Bridge
Wrist Extension
Wrist Curl
Lat Shrug
Reverse Fly

A method and system for creating personalized workout programs have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the appended claims would be evident to a person skilled in the art.

We claim:

1. A computer-implemented method, comprising:
receiving first input data from a client device, the first input data comprising personal information, fitness goal information, and scheduling data;
generating, based on the first input data, a recommended workout schedule and a recommended list of activity groups;
receiving second input data from the client device, the second input data comprising feedback related to the recommended list of activity groups;
generating, based on the first input data and second input data, a personalized workout plan; and
transmitting the personalized workout plan, wherein the personalized workout plan is displayable on the client device.

2. The computer-implemented method of claim 1, further comprising:
determining session types for the recommended workout schedule.

3. The computer-implemented method of claim 1, further comprising:
determining exercises to assign to a workout schedule.

4. The computer-implemented method of claim 1, further comprising:
determining movement pattern templates.

5. The computer-implemented method of claim 1, wherein the personalized workout plan is a yoga workout.

6. The computer-implemented method of claim 1, wherein the personalized workout plan is a cardio workout.

7. A system, comprising:
a server in communication with a network; and
computer instructions executable by the server, the computer instructions comprising causing the server to perform
receiving first input data from a client device, the first input data comprising personal information, fitness goal information, and scheduling data;
generating, based on the first input data, a recommended workout schedule and a recommended list of activity groups;
receiving second input data, the second input data comprising feedback related to the recommended list of activity groups;
generating, based on the first input data and second input data, a personalized workout plan; and
transmitting the personalized workout plan, wherein the personalized workout plan is displayable on the client device.

8. The system of claim 7, wherein the server is further configured to perform:
determining session types for the recommended workout schedule.

9. The system of claim 7, wherein the server is further configured to perform:
determining exercises to assign to a workout schedule.

10. The system of claim 7, wherein the server is further configured to perform:
determining movement pattern templates.

11. The system of claim 7, wherein the personalized workout plan is a yoga workout.

12. The system of claim 7, wherein the personalized workout plan is a cardio workout.

13. A non-transitory computer-readable medium having stored thereon a plurality of instructions, said plurality of instructions when executed by a processor cause said processor to perform:
receiving first input data from a client device, the first input data comprising personal information, fitness goal information, and scheduling data;
generating, based on the first input data, a recommended workout schedule and a recommended list of activity groups;
receiving second input data, the second input data comprising feedback related to the recommended list of activity groups;
generating, based on the first input data and second input data, a personalized workout plan; and
transmitting the personalized workout plan, wherein the personalized workout plan is displayable on the client device.

14. The computer-readable medium of claim 13, wherein said plurality of instructions further cause said processor to perform:
determining session types for the recommended workout schedule.

15. The computer-readable medium of claim 13, wherein said plurality of instructions further cause said processor to perform:
determining exercises to assign to a workout schedule.

16. The computer-readable medium of claim 13, wherein said plurality of instructions further cause said processor to perform:
determining movement pattern templates.

17. The computer-readable medium of claim 13, wherein the personalized workout plan is a yoga workout.

18. The computer-readable medium of claim 13, wherein the personalized workout plan is a cardio workout.
